(19) United States
(12) Patent Application Publication
(10) Pub. No.: US 2015/0331195 A1
(43) Pub. Date: Nov. 19, 2015

(54) OPTICAL COUPLING CONNECTOR

(71) Applicant: Hon Hai Precision Industry Co., Ltd., New Taipei (TW)

(72) Inventor: YI HUNG, Tu-Cheng (TW)

(73) Assignee: HON HAI PRECISION INDUSTRY CO., LTD., New Taipei (TW)

(21) Appl. No.: 14/141,439

(22) Filed: Dec. 27, 2013

(30) Foreign Application Priority Data
Jan. 14, 2013 (TW) 102101262

(51) Int. Cl. G02B 6/32; G02B 6/38

(52) U.S. Cl. CPC G02B 6/32; G02B 6/3809

(57) ABSTRACT

An exemplary optical coupling connector includes a main body, a number of coupling lenses; two guide members and a cover. The main body includes a coupling surface, a mounting surface opposite to the coupling surface and a top surface perpendicularly to the mounting surface. The coupling surface includes a first mounting area. The mounting surface includes a second mounting area, and the first mounting area corresponds to the second mounting area. The top surface defines a number of first receiving grooves for receiving optical fibers. The coupling lens is located at the second mounting area. The guide members protrude outwardly from the coupling surface, the two guide members are arranged at intervals and the first mounting area is arranged between the two guide members. The main body, the coupling lenses and the guide members are integrally formed in one monolithic piece.

### BACKGROUND

1. Technical Field

The present disclosure relates to optical coupling connectors.

2. Description of Related Art

An optical coupling connector generally includes a coupling lens portion having coupling lenses, and a receiving portion configured for receiving optical fibers. An optical signal is coupled into a given optical fiber through the corresponding coupling lens of the coupling lens portion. However, the coupling lens portion and the receiving portion are usually separate structures. When the coupling lens portion and the receiving portion are assembled together, a given coupling lens of the coupling lens portion and the corresponding optical fiber in the receiving portion may not be accurately aligned. If this happens, there may be loss of optical signals during operation.

Therefore, it is desired to provide an optical coupling connector which can overcome the above-mentioned problems.

### BRIEF DESCRIPTION OF THE DRAWINGS

FIG. 1 is a schematic, isometric view of an optical coupling connector according to a first exemplary embodiment.

FIG. 2 is a cross-sectional view taken along line II-II of FIG. 1.

FIG. 3 is an exploded view of the optical coupling connector of FIG. 1.

FIG. 4 is similar to FIG. 3, but viewed from another aspect.

FIG. 5 is a schematic, isometric view of an optical coupling connector according to a second exemplary embodiment.

FIG. 6 is an exploded, isometric view of an optical coupling connector according to a third exemplary embodiment.

FIG. 7 is an exploded, isometric view of an optical coupling connector according to a fourth exemplary embodiment.

FIG. 8 is an assembled view of FIG. 7.

FIG. 9 is a cross-sectional view taken along line IX-IX of FIG. 8.

### DETAILED DESCRIPTION

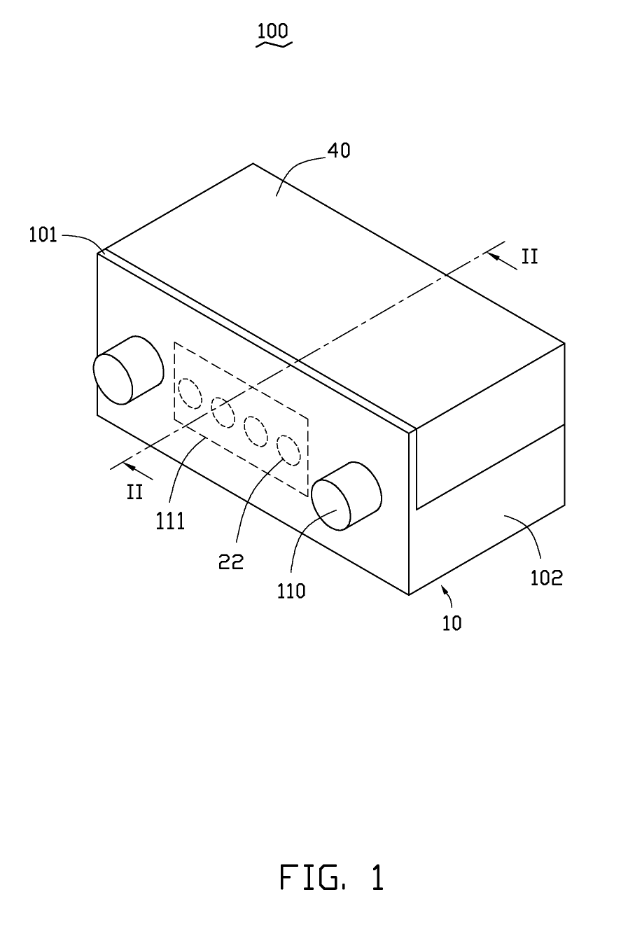

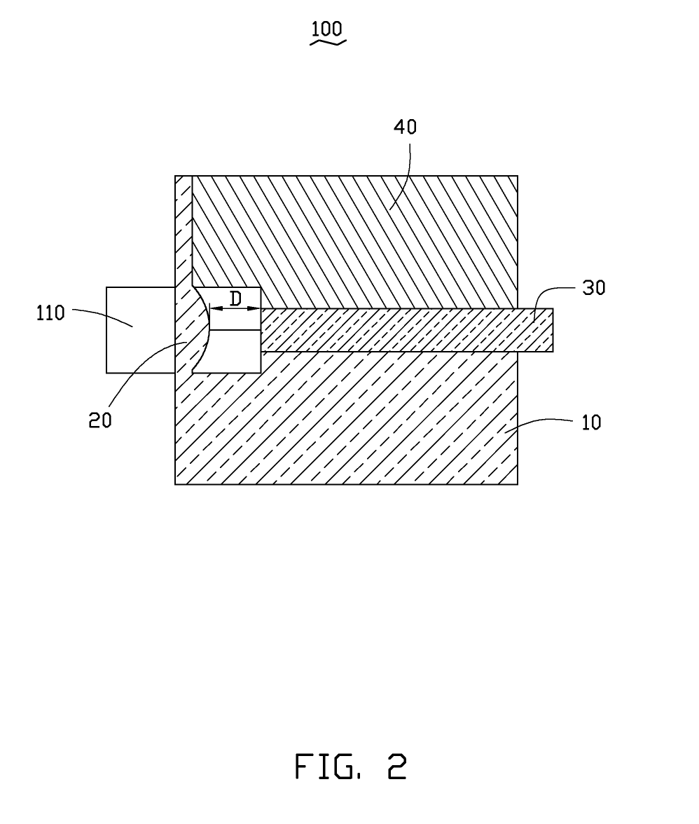

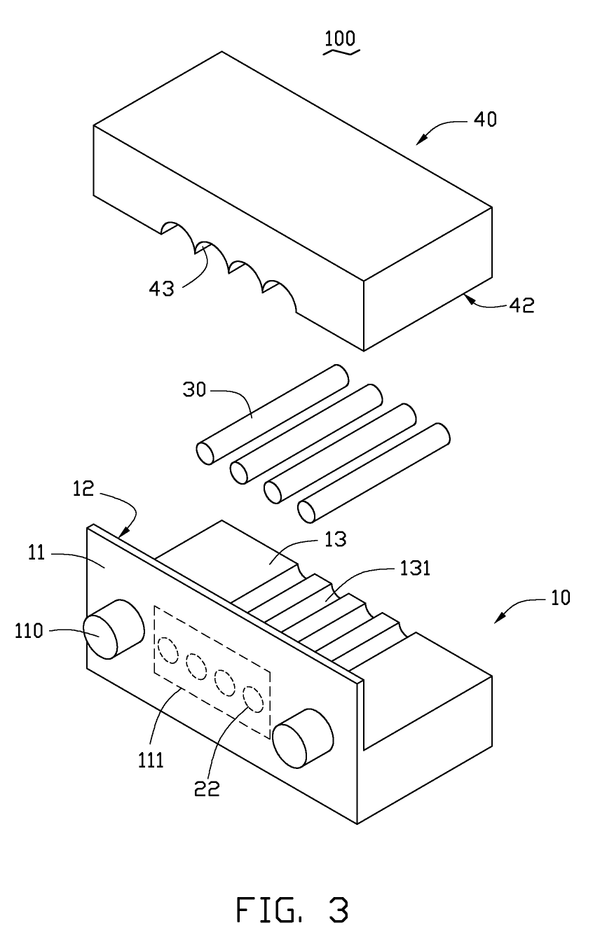

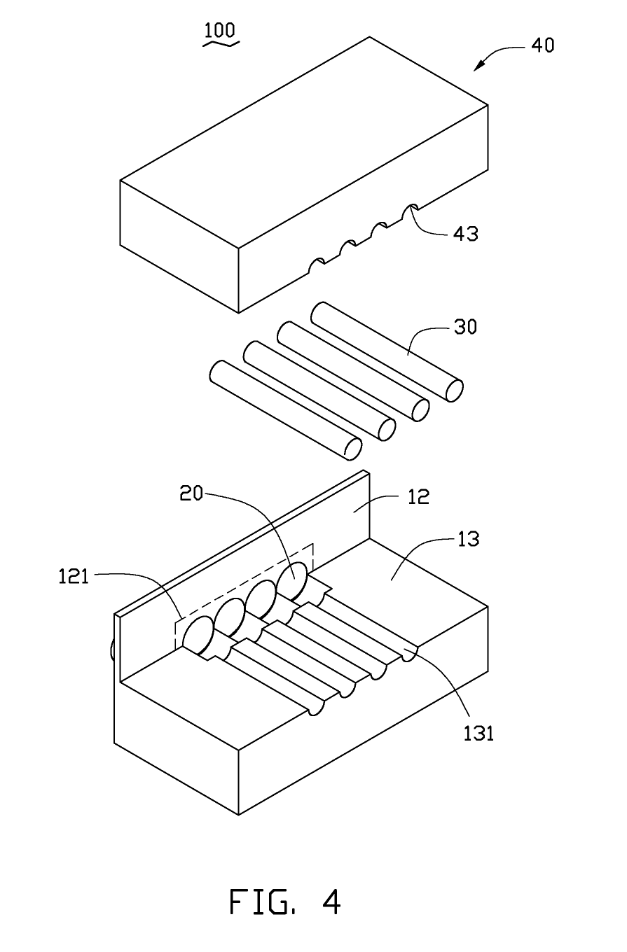

FIGS. 1-4 show an optical coupling connector 100 according to a first exemplary embodiment. The optical coupling connector 100 includes a main body 10, a number of coupling lenses 20, a number of optical fibers 30, two guide members 110, and a cover 40. The cover 40 is substantially in the shape of a solid body.

A transverse cross-section of the main body 10 defines a substantially L-shaped two-dimensional area. The main body 10 includes a transparent front plate portion 101, and a lower block portion 102 perpendicularly connected to the front plate portion 101. The front plate portion 101 includes a coupling surface 11 and a mounting surface 12 at opposite sides thereof The lower block portion 102 includes a top surface 13, which is perpendicularly connected to the mounting surface 12. The coupling surface 11 includes a first mounting area 111, and the mounting surface 12 includes a second mounting area 121. The first mounting area 111 corresponds to the second mounting area 121. The top surface 13 defines a number of first receiving grooves 131 configured for receiving the optical fibers 30. A lengthwise (extending) direction of each first receiving groove 131 is perpendicular to the mounting surface 12. Each first receiving groove 131 defines a semicircular transverse cross-section.

The coupling lenses 20 are located on the second mounting area 121. The two guide members 110 are spaced apart, and the first mounting area 111 is located between the two guide members 110. The guide members 110 are substantially in the form of cylinders, and protrude outwardly from the coupling surface 11. An imaginary (or virtual) connection line between two centers of the two guide members 110 at the coupling surface 11 runs through a center of the first mounting area 111. The guide members 110 are configured for mechanically connecting to other optical coupling connectors. The main body 10, the coupling lenses 20 and the guide members 110 are integrally formed into one monolithic piece by a molding process. The cover 40 includes a bottom surface 42, which is fixed on the top surface 13 by glue. The bottom surface 42 defines a number of second receiving grooves 43, which are aligned with the first receiving grooves 131. The second receiving grooves 43 and the first receiving grooves 131 are together used for receiving the optical fibers 30. In this embodiment, a front end of each optical fiber 30 is planar, and is aligned with both a front end of the corresponding first receiving groove 131 and a front end of the corresponding second receiving groove 43. In particular, the front ends of all the optical fiber 30 are substantially coplanar.

The first mounting area 111 also defines a number of virtual (or reference) circles 22. Each virtual circle 22 corresponds to a coupling lens 20, and the size of the virtual circle 112 is equal to the size of the coupling lens 20. Typically, an emitter of another complementary optical coupling connector (not shown) aims at a given one of the virtual circles 22. Optical signals from the emitter reach the corresponding coupling lens 20, and the coupling lens 20 functions to couple the optical signals into the corresponding optical fiber 30.

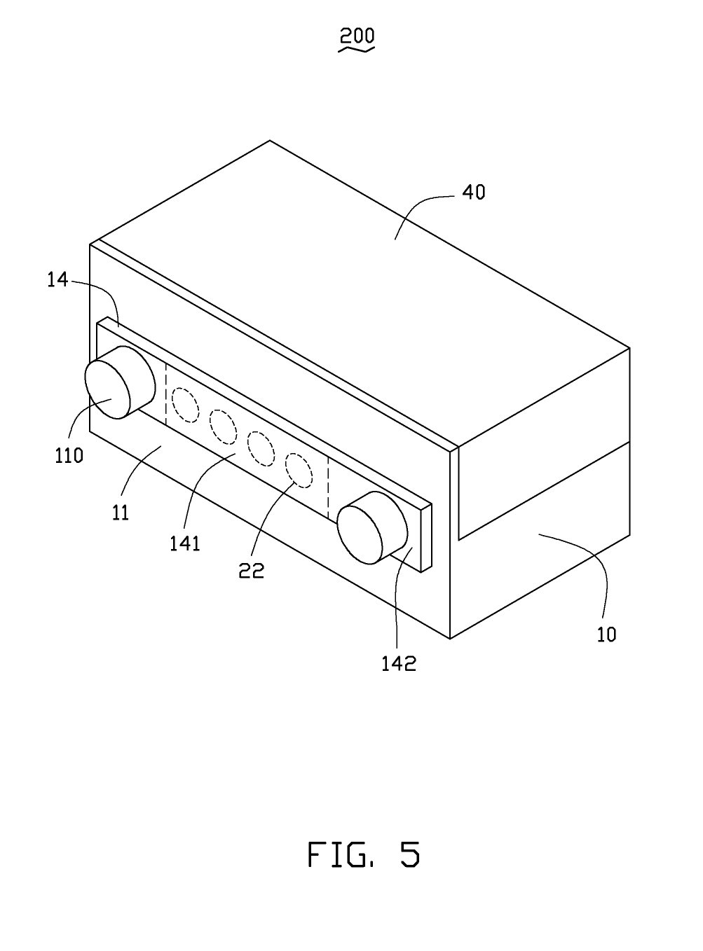

FIG. 5 shows an optical coupling connector 200 according to a second exemplary embodiment. The difference between the optical coupling connector 200 and the optical coupling connector 100 is that the optical coupling connector 200 further includes a forward plate portion 14 arranged on the mounting surface 11. The forward plate portion 14 is substantially a cuboid, and covers the first mounting area 111. The forward plate portion 14 includes a photopermeable area 141, and two non-photopermeable areas 142 positioned at two opposite sides of the photopermeable area 141. The two guide members 110 are arranged on the non-photopermeable areas 142. The photopermeable area 142 is transparent, and permits optical signals to pass therethrough. The forward plate portion 14 is configured for mechanically connecting to other optical coupling connectors. The main body 10, the coupling lenses 20, the forward plate portion 14 and the guide members 110 are integrally formed into one monolithic piece by a molding process.

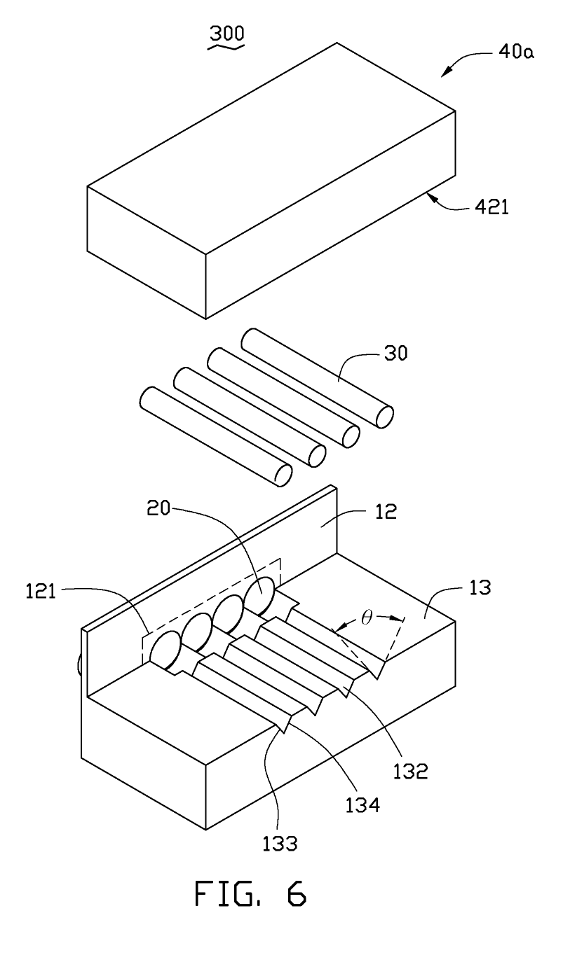

FIG. 6 shows an optical coupling connector 300 according to a third exemplary embodiment. One main difference between the optical coupling connector 300 and the optical coupling connector 100 is that each of first receiving grooves 132 defines a V-shaped cross-section. Each first receiving groove 132 includes a first inclined surface 133, and a second inclined surface 134 connected to the first inclined surface 133. An included angle θ formed between the first inclined surface 133 and the second inclined surface 134 is about 60°. An area of the first inclined surface 133 is equal to an area of the second inclined surface 134. In this embodiment, a cover 40a includes a bottom surface 421, and the entire bottom surface 421 is a plane surface.

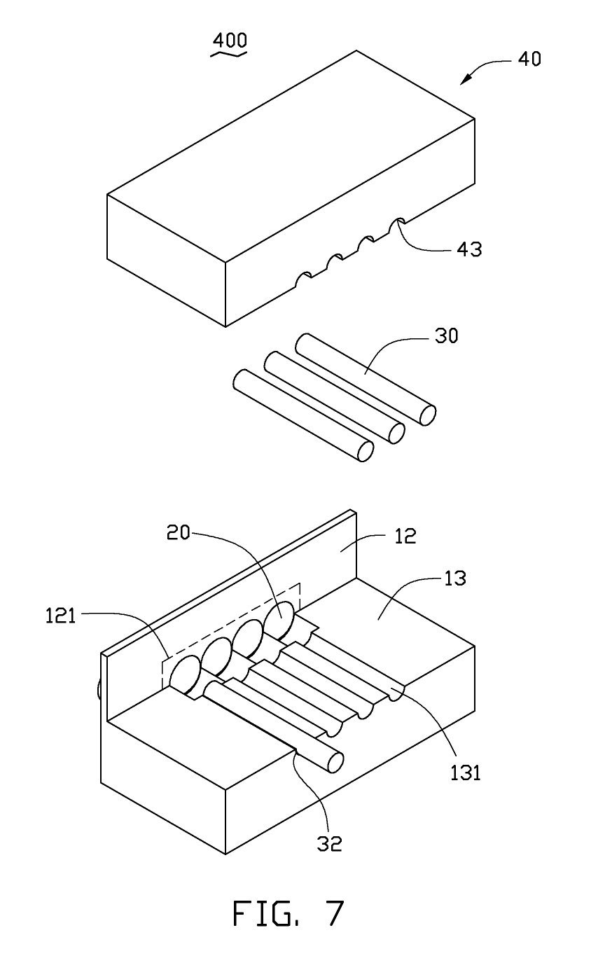

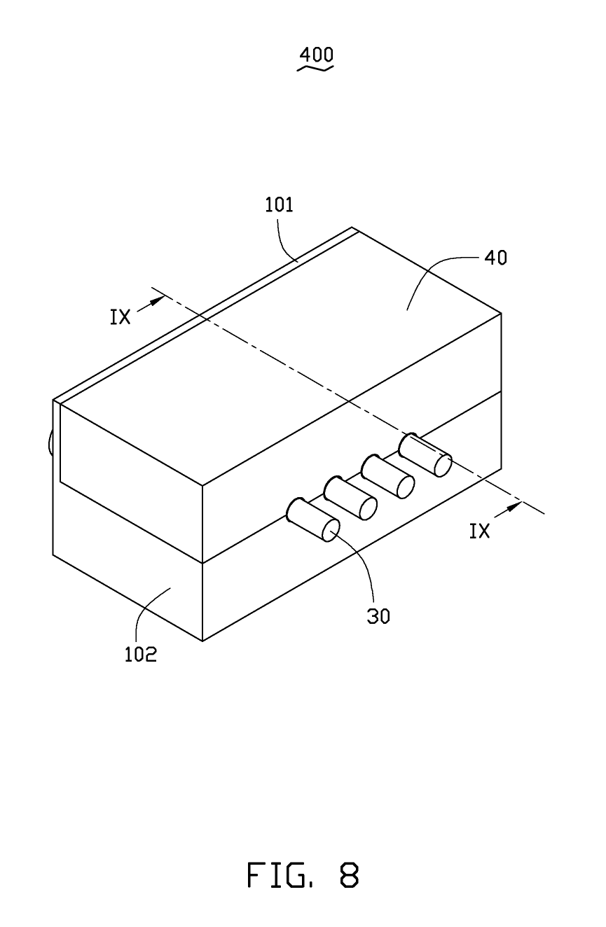

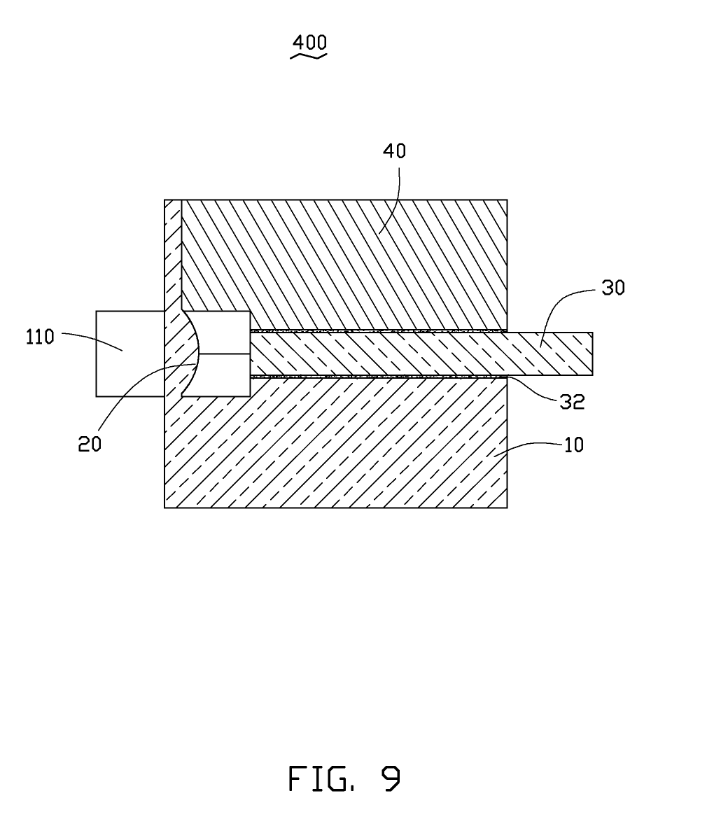

FIGS. 7-9 show an optical coupling connector 400 according to a fourth exemplary embodiment. The optical coupling connector 400 is very similar to the optical coupling connector 100. The difference between the optical coupling connector 400 and the optical coupling connector 100 is that in the optical coupling connector 400, the optical fibers 30 are fixed in the first receiving grooves 131 and the second receiving grooves 43 by glue 32.

Taking the optical coupling connector 400 as an example, the main body 10 and the coupling lenses 20 are integrally formed into one monolithic piece (together with the guide members 110). Such monolithic piece can for example be made of the one same material. Therefore it is easier to achieve accurate alignment of the optical fibers 30 (received in the first and second receiving grooves 131, 43) and the coupling lenses 20. Furthermore, the plurality of coupling lenses 20 and the pair of guide members 110 are positioned at opposite sides of the front plate portion 101 of the main body 10, with the coupling lenses 20 covered by the cover 40. This configuration can protect the coupling lenses 20 from soiling or damage.

It is to be understood, however, that even though numerous characteristics and advantages of the present embodiments have been set forth in the foregoing description, together with details of the structures and functions of the embodiments, the disclosure is illustrative only; and that changes may be made in detail, especially in the matters of shape, size, and arrangement of parts within the principles of the disclosure to the full extent indicated by the broad general meaning of the terms in which the appended claims are expressed.

What is claimed is:

1. An optical coupling connector comprising:
a main body comprising a front plate portion and a lower block portion;
the front plate portion comprising a coupling surface and a mounting surface at opposite sides thereof, the lower block portion comprising a top surface perpendicularly connected to the mounting surface;
the coupling surface comprising a first mounting area, the mounting surface comprising a second mounting area, the first mounting area corresponding to the second mounting area, the top surface defining a plurality of first receiving grooves configured for receiving optical fibers, an extending direction of each of the first receiving grooves being perpendicular to the mounting surface;
a plurality of coupling lenses located at the second mounting area, the first mounting area defining a plurality of virtual circles, each virtual circle corresponding to one of the coupling lenses;
two guide members protruding outwardly from the coupling surface and being spaced apart, the first mounting area being located between the two guide members; and
the main body, the coupling lenses and the guide members being integrally formed as a single monolithic piece; and
a cover fixed on the top surface.

2. The optical coupling connector of claim 1, wherein the main body has a substantially L-shaped cross-section.

3. The optical coupling connector of claim 1, wherein each of the first receiving grooves defines a semicircular transverse cross-section.

4. The optical coupling connector of claim 3, wherein the cover comprises a bottom surface, and the bottom surface defines a plurality of second receiving grooves aligned with the first receiving grooves.

5. The optical coupling connector of claim 1, wherein each of the first receiving grooves defines a V-shaped transverse cross-section.

6. The optical coupling connector of claim 5, wherein the cover comprises a bottom surface, and the bottom surface is a plane surface.

7. The optical coupling connector of claim 5, wherein each of the first receiving grooves comprises a first inclined surface and a second inclined surface connected to the first inclined surface, and an included angle formed between the first inclined surface and the second inclined surface is about 60°.

8. The optical coupling connector of claim 1, wherein the guide members are substantially cylinders.

9. The optical coupling connector of claim 1, wherein the cover is substantially in the shape of a solid cuboid body.

10. The optical coupling connector of claim 1, wherein the main body further comprises a forward plate portion arranged on the mounting surface, the forward plate portion is substantially a cuboid, the forward plate portion covers the first mounting area, and the main body, the coupling lenses, the forward plate portion and the guide members are integrally formed as a single monolithic piece.

11. The optical coupling connector of claim 10, wherein the forward plate portion comprises a photopermeable area and two non-photopermeable areas beside the photopermeable area, and the two guide members are arranged on the non-photopermeable areas.

12. An optical coupling device comprising:
a main body comprising a front plate portion and a lower block portion;
the front plate portion comprising a coupling surface and a mounting surface at opposite sides thereof, the lower block portion comprising a top surface perpendicularly connected to the mounting surface;
the coupling surface comprising a first mounting area, the mounting surface comprising a second mounting area, the first mounting area corresponding to the second mounting area, the top surface defining a plurality of first receiving grooves configured for receiving optical fibers, an extending direction of each of the first receiving grooves being perpendicular to the mounting surface;
a plurality of coupling lenses located at the second mounting area;
two guide members protruding outwardly from the coupling surface and being spaced apart, the first mounting area being located between the two guide members; and
the main body, the coupling lenses and the guide members being integrally formed as a single monolithic piece;
a plurality of optical fibers; and
a cover fixed on the top surface;
each optical fiber being fixed in a corresponding one of the first receiving grooves, a front end of the optical fiber being aligned with a front end of the first receiving groove, and a distance between a center of each coupling lens and the front end of the corresponding first receiving groove being equal to a focal length of the coupling lens.

13. The optical coupling connector of claim 12, wherein each of the first receiving grooves defines a semicircular transverse cross-section.

14. The optical coupling connector of claim 13, wherein the cover comprises a bottom surface, the bottom surface defines a plurality of second receiving grooves aligned with the first receiving grooves, and each optical fiber is further fixed in a corresponding one of the second receiving grooves.

15. The optical coupling connector of claim 14, wherein each optical fiber is fixed in the corresponding first receiving groove and the corresponding second receiving groove by glue.

16. The optical coupling connector of claim 12, wherein each of the first receiving grooves defines a V-shaped transverse cross-section.

17. The optical coupling connector of claim 16, wherein the cover comprises a bottom surface, and the bottom surface is a plane surface.

18. An optical coupling device comprising:
a main body comprising a front plate portion and a lower block portion;
the front plate portion comprising a coupling surface and a mounting surface at opposite sides thereof, the lower block portion comprising a top surface perpendicularly connected to the mounting surface;
the coupling surface comprising a first mounting area, the mounting surface comprising a second mounting area, the first mounting area corresponding to the second mounting area, the top surface defining a plurality of first receiving grooves configured for receiving optical fibers, an extending direction of each of the first receiving grooves being perpendicular to the mounting surface;
a plurality of coupling lenses located at the second mounting area;
two guide members protruding outwardly from the coupling surface and being spaced apart, the first mounting area being located between the two guide members; and
the main body, the coupling lenses and the guide members being integrally formed as a single monolithic piece;
a plurality of optical fibers; and
a cover fixed on the top surface;
each optical fiber being fixed in a corresponding one of the first receiving grooves, a front end of the optical fiber being aligned with a front end of the first receiving groove.

19. The optical coupling connector of claim 18, wherein the main body further comprises a forward plate portion arranged on the mounting surface, the forward plate portion is substantially a cuboid, the forward plate portion covers the first mounting area, and the main body, the coupling lenses, the forward plate portion and the guide members are integrally formed as a single monolithic piece.

20. The optical coupling connector of claim 18, wherein the forward plate portion comprises a photopermeable area and two non-photopermeable areas beside the photopermeable area, and the two guide members are arranged on the non-photopermeable areas.
